(19) United States
(12) Patent Application Publication
(10) Pub. No.: US 2012/0208012 A1
(43) Pub. Date: Aug. 16, 2012

(54) SEMICONDUCTOR PROCESSING SHEET

(75) Inventors: Keisuke Watanabe, Ibaraki-shi (JP); Masakazu Morimoto, Ibaraki-shi (JP); Junki Mori, Ibaraki-shi (JP); Masayoshi Natsume, Ibaraki-shi (JP)

(73) Assignee: NITTO DENKO CORPORATION, Ibaraki-shi, Osaka (JP)

(21) Appl. No.: 13/388,879

(22) PCT Filed: Jul. 20, 2010
(86) PCT No.: PCT/JP2010/062140

§ 371 Date: Apr. 16, 2012

(30) Foreign Application Priority Data
Aug. 4, 2009 (JP) 2009-181174
Jun. 11, 2010 (JP) 2010-133475

(51) Int. Cl. B32B 27/18; B24B 7/16; C09J 7/02

(52) U.S. Cl. 428/354; 428/411.1; 451/540

(57) ABSTRACT

A semiconductor processing sheet contains a base layer having a plastic sheet containing pigment as a core layer, wherein a non-pigment-containing layer is arranged in the outermost layer on front and back main surfaces of the core layer. According to the present invention, in a process for manufacturing semiconductor devices, it is possible to minimize contamination of the inner surface for the film manufacturing die that is due to the pigment contained in the film while maintaining the visibility of the semiconductor processing sheet. Consequently, partial occlusion of the die lip aperture due to pigment contamination is reduced, with the result that effective prevention of the deterioration of the sheet thickness precision due to adhering pigment is possible.

### TECHNICAL FIELD

The present invention relates to a semiconductor processing sheet, and more specifically, to a semiconductor processing sheet that includes a plastic sheet containing pigment.

### BACKGROUND ART

Conventionally, pigment is added to impart visibility when an adhesive sheet for manufacturing semiconductor devices used in a method for manufacturing semiconductor devices is attached to the semiconductor wafer (see for example, Patent Document 1).

However, the pigment contained in the adhesive sheet can migrate and become attached to the outermost layer of the adhesive sheet, and as a result there are concerns about contamination of the manufacturing facility, the interior of the manufacturing equipment, for example, the inner surface of the die lip for film manufacture and the like.

### PRIOR ART LITERATURE

### Patent Literature

[Patent Document 1] Japanese Published Unexamined Patent Application No. 2005-191296

### SUMMARY OF THE INVENTION

### Problem to be Solved by the Invention

Taking account of the aforementioned problem, the present invention has the goal of providing a semiconductor processing sheet wherein, during the film-forming step of a semiconductor processing sheet in a process for manufacturing semiconductor devices, the causes of deterioration in sheet thickness precision, contamination due to the blended pigment of the inner surfaces of the die lip or the like, and the consequent partial occlusion or the like of the aperture part of the die lip or the like, can be kept to a minimum.

### Means to Solve the Problem

A semiconductor processing sheet of the present invention contains a base layer having a plastic sheet containing pigment as a core layer, wherein a non-pigment-containing layer is arranged in the outermost layer on front and back main surfaces of the core layer.

In such semiconductor processing sheet, it is preferably that the non-pigment-containing arranged in the outermost layer on one main surface of the core layer is formed by an adhesive layer.

It is preferably that the non-pigment-containing layer arranged on at least one of the front and back main surfaces is formed using the same material that is used to the core layer.

It is preferably that the sheet is used as a wafer back surface polishing sheet.

### Effect of the Invention

According to the present invention, it is possible to minimize contamination of the inner surface for the film manufacturing die that is due to the pigment contained in the film while maintaining the visibility of the semiconductor processing sheet in a process for manufacturing semiconductor devices. Consequently, partial occlusion of the die lip aperture due to pigment contamination is reduced, with the result that effective prevention of the deterioration of the sheet thickness precision due to adhering pigment is possible.

### MODES FOR IMPLEMENTING THE INVENTION

A semiconductor processing sheet of the present invention includes at least base layer. This base layer includes a pigment-containing plastic sheet as a core layer, and is constituted by arranging a non-pigment-containing layer on the outermost layers of two main faces (front and back surface) of this core layer.

Thus, “semiconductor processing sheet” indicates a sheet that is used in various processes in semiconductor processing. This semiconductor processing sheet is laminated onto a work piece that is a wafer or the like and is formed from silicon, SiC, GaN, GaAs or the like, and can be used in various processes for front and back surface polishing sheets or the like as protective sheets (during dicing, CMP, etching, or the like) or as a dicing sheet. The semiconductor processing sheet of the present invention is provided with not only a base layer, but it is also preferably provided with one or two or more adhesive layers to fix the wafer, manufactured device, or the like. Moreover, one or more different types of layer can optionally be provided in addition to the adhesive layers to impart various functions.

In particular, the semiconductor processing sheet of the present invention can effectively prevent pigment contamination when used as a wafer back-grinding protective sheet and attached directly to the circuits of the wafer or the like, as a protective sheet for circuit surfaces.

The core layer in the base layer imparts autonomy to the semiconductor processing sheet, and can be formed as a plastic sheet, for example, made from a polyolefin such as polyethylene, polypropylene (more specifically, low-density polyethylene, straight chain low-density polyethylene, high-density polyethylene, oriented polypropylene, non-oriented polypropylene, ethylene-propylene copolymer, ethylene-vinyl acetate copolymer (EVA), ethylene-(meth)acrylate copolymer, ethylene-(meth)acrylate ester copolymer, or the like; polyurethane, polytetrafluoroethylene, polyimide, polyamide, acetal resin, polyester, polyethylene terephthalate, polyethylene naphthalate, polycarbonate, fluoric resin, polystyrene, rubber component-containing polymer such as styrene-butadiene copolymer; resins enhanced by glass fiber or plastic nonwoven fabric, or the like.

Here, “(meth) acrylic” means both “acrylic” and “methacrylic”.

In general, the core layer can be molded to contain various additives. Thus, pigments can be contained in the core layer. Furthermore, a “pigment” is a white or colored powder that is insoluble in water, oil or the like, and includes both organic and inorganic pigments. Generally, these are materials used as printing ink, paint, coloring agents for plastic, rubber, or the like. Also, the pigment is included a material which has the function of fillers, vehicles, or a material that has the function of adjusting the constitution (properties of coloring strength, hue, electrical insulation, etc.). The pigment composition itself, without being limiting in any particular way, usually contains metallic elements. Such metallic elements take the form of compounds, complexes, ions, or the like, but complexes in particular are not desirable as pigments and readily cause contamination. Examples of metallic elements contained in pigments include copper, iron, titanium, magnesium, manganese, aluminum, cobalt, zinc, silver, gold, nickel, chrome, tin, palladium, and the like.

The thickness of the core layer, without being limiting in any particular way, can be suitably adjusted to provide a degree of strength and the like that enables its function as the base layer of the semiconductor processing sheet. For example, approximately 10 to 400 μm is satisfactory, and 30 to 250 μm is preferred.

The non-pigment-containing layer is arranged in the outermost layer on the front and back main surfaces of the core layer. In other words, no layer is arranged in the outermost layer in the semiconductor processing sheet of the present invention that would bring about contamination by pigments, specifically metallic elements that give rise to pigments (in particular, complexes and the like) in a surface that is in direct contact with a wafer surface, manufacturing facility, the interior of the manufacturing equipment, or the like.

Here, “front and back main surfaces” indicates the front surface and back surface that extend over a core layer that is a two-dimensional sheet having a given thickness.

In this way, by arranging a non-pigment-containing layer in the outermost layer on the front and back surfaces of the core layer, in the film manufacturing step, the non-pigment-containing layer minimizes contamination of the interior surfaces in the film-forming equipment and partial occlusion thereof (e.g., contamination of the interior surfaces of the die lip or the like, and partial occlusion of the openings) caused by the blended pigments, and furthermore, contamination of the base layer surfaces due to the pigments in the core layer can be prevented or blocked.

For this reason, pigments are substantially absent from the non-pigment-containing layer. Thus, for such a function to be realized effectively, attempts are made to balance the various factors, not only the material and thickness of the core layer, but also the material, thickness and positioning of the non-pigment-containing layer, the material and thickness of the adhesive layer described below, and the like.

That the non-pigment-containing layer does not contain any pigment means that no pigment (for example, metallic elements) is contained in any of the materials that are used as a starting material for the non-pigment-containing layer. In addition, this means that when the semiconductor processing sheet is manufactured, contamination of surfaces due to pigment or the adherence of pigment to surfaces is substantially prevented or essentially prevented.

An example of a method for determining whether there is substantially or essentially no contamination or adherence due to the pigment, as mentioned above, is the method of determination by visual inspection of the manufacturing facility, the interior of the manufacturing equipment, or the like, e.g., the inner surface itself of the die lip used in manufacturing the film or the like.

An additional example is the method of determination by visual inspection of whether or not streaks are present on the surface of the film formed utilizing the die lip used in manufacturing the film or the like.

Furthermore, after a semiconductor processing sheet is applied to and peeled off from a target semiconductor work piece, when the material (for example, metal) transferred to the target semiconductor work piece (for example, a silicon wafer mirror surface) from the outermost surface of the non-pigment-containing layer is measured by ICP-MS (inductively coupled plasma mass spectrometry), for example, the amount of metal measured on the surface of the target semiconductor work piece is 1.0×10¹⁰ atoms/cm² or less. Moreover, depending on the precision of the measurement apparatus, approximately 1×10¹⁰ atoms/cm² or less is suitable, and it is preferably at or below the measurement threshold.

Here, any of the normally used apparatus, procedures, conditions, or the like, can be used in the ICP-MS measurement method. Specifically,

(1) First, the semiconductor processing sheet is attached to the target semiconductor work piece (for example, wafer of 100 mm thickness), a fixed-load rubber roller (for example, 2 kg) is rolled back and forth over the sheet, after which the sheet is peeled off.

(2) Next, the entire amount of the oxide layer on the surface of the sheet that was attached to/peeled off from the target semiconductor work piece is etched with a suitable etchant, for example, hydrofluoric acid. The entire amount of the solution obtained using the etchant is collected in an evaporating dish, this is heated and evaporated to dryness, and the residue is dissolved in acid to give the test solution for measurement.

(3) Next, the test solution for measurement obtained is measured using ICP-MS.

(4) From the mass of the element(s) obtained from the measurement (ng), for example Cu (or the abovementioned metallic elements), the number of moles is calculated by dividing by the atomic weight, and this is converted to the number of atoms by multiplying by Avogadro's number. This value can be divided by the surface area of the target semiconductor work piece that was etched (for example, 78.5 cm²) to calculate the number of atoms per unit surface area (atoms/cm²).

In addition, other determination methods besides ICP-MS can also be used, such as total reflection x-ray fluorescence.

In such a method, respectively, detection of a measured value for metal that is approximately 1×10¹² atoms/cm² or less is suitable, 1×10¹¹ atoms/cm² or less is preferred, and a measured value that is at or below the detection limit is further preferred.

As a further additional determination method, X-ray photoelectron spectroscopy can also be used. In this case, the semiconductor processing sheet is attached to the target semiconductor work piece, and this is allowed to stand for 1 day at 40° C. and is then peeled off. When this is measured using an Ulvac Phi Model 5400, the quantity of organic compound transferred onto the target semiconductor work piece from the non-pigment-containing layer, in other words, the quantity of organic compound transferred onto the surface of the target semiconductor work piece, is preferably 5 atom % or higher and 16 atom % or lower.

As mentioned above, to prevent the diffusion of pigment to the work piece or the like, suitable materials for the non-pigment-containing layer can be selected from among the same materials used to constitute the abovementioned core layer so long as pigment, in particular metallic elements, is not contained therein. Among these, the non-pigment-containing layer arranged on at least one of the front and back main surfaces, is preferably formed using the same material that is used to constitute the core layer.

The thickness of the non-pigment-containing layer, without being limiting in any particular way, is preferably such that it can function as the base layer of the semiconductor processing sheet. Additionally, this can be suitably adjusted to provide effective prevention of the pigment from diffusing, permeating, adhering, or the like, in the manufacturing process for the semiconductor processing sheet. For example, it can exhibit a value of approximately 0.5 to 250 μm.

In particular, normally, the non-pigment-containing layer can be arranged in between laminated adhesive layers in the semiconductor processing adhesive sheet, but it can also be the adhesive sheet itself.

In this way, when the non-pigment-containing layer is arranged on the adhesive layer side or as the adhesive layer, contamination of the semiconductor work piece due to pigment derived from the core layer can more reliably be prevented. For example, when the core layer is being extrusion molded in the state of being sandwiched in between non-pigment-containing layers, contamination of the inner surfaces of the extruder by the metallic pigments contained in the outermost layer can be reduced, and not only can the precision of the thickness be increased, but contamination of the adherend material by pigments can also be prevented.

Without being limiting in any particular way, adhesives that can be used in the adhesive layer can include thermoplastic resins, thermosetting resins, thermoplastic resins and thermosetting resins used concomitantly, or the like, for example, the adhesive that is usually employed in the corresponding field such as described in Japanese published unexamined patent application No. 2008-91765. Furthermore, the resin raw materials and various additives that constitute the adhesive layer preferably do not contain pigments.

Examples of thermoplastic resins include rubber polymers (natural rubbers such as polyisoprene, synthetic rubber such as butyl rubber, styrene-butadiene rubber, polybutadienes, butadiene-acrylonitriles, chloroprenes rubber), ethylene-vinyl acetate copolymers, ethylene-acrylate copolymer, ethylene-acrylate ester copolymer, polycarbonate resin, thermoplasticity polyimide resin, polyamide such as 6-nylon and 6,6-nylon, phenoxy resin, acrylicresin, saturated polyester resins such as PET and PBT, polyamide-imide resin, fluoric resin, or the like. Among these, particularly preferable are acrylic resins with few ionic impurities and high heat resistance that can maintain the reliability of semiconductors.

Examples of monomer components that constitute (meth)acrylic polymers include (meth)acrylates having C₃₀ or lower, preferably C₄ to C₁₈, straight chain or branched alkyl group. The (meth)acrylic polymer is optionally added multifunctional monomer for the purpose of cross link, monomer and/or oligomer having an energy-curing functional group such as carbon-carbon double bond, or the like, polymerization initiator, photopolymerization initiator, cross-linker, or the like.

Examples of thermosetting resins include phenolic resins, amino resins, unsaturated polyester resins, epoxy resins, polyurethane resins, silicone resins, thermosetting polyimide resins, and the like. Among these, epoxy resins that contain few ionic impurities which corrode semiconductor elements are preferred.

Furthermore, additives suitable for use in the corresponding field can also be employed for the adhesive layer, but such additives are suitable if they contain no pigments.

Without being limiting in any particular way, the thickness of the adhesive layer is suitable if it can maintain adequate adhesive strength. Additionally, for example, this is preferably adjusted to provide effective prevention of the pigment from diffusing, permeating, adhering, or the like, from the core layer during the manufacturing process for the semiconductor processing sheet. For example, the thickness can exhibit a value of approximately 5 to 300 μm.

In this way, the constitution of the semiconductor processing sheet of the present invention can have various laminated structures including,

(1) non-pigment-containing layer/core layer/adhesive layer,

(2) non-pigment-containing layer/core layer/non-pigment-containing layer/adhesive layer,

(3) adhesive layer/non-pigment-containing layer/core layer/non-pigment-containing layer/adhesive layer, and the like.

Furthermore, the thickness of such layers can be in the ranges mentioned above, but depending on the conditions of the laminated layer, the layers can function as the semiconductor processing sheet itself, and the thickness is preferably adjusted to enable the function of preventing contamination due to pigments that arise from the core layer.

A semiconductor processing sheet of the present invention can be formed using manufacturing methods for semiconductor processing sheets that are well known in the art. For example, first a core layer and a non-pigment-containing layer are prepared. These layers may be prepared by molding them into respective individual sheets, prepared by lamination into layers, or prepared by molding integrally using an extruder.

Optionally, the adhesive layer can be laminated onto the base layer. In this case, the adhesive layer can be laminated or coated or the like directly onto the core layer or onto a non-pigment-containing layer, the adhesive can be coated onto a processing sheet that is coated with a parting agent and then dried, after which the adhesive layer can be laminated onto the core layer or the non-pigment-containing layer using a transfer coating method. In addition, the non-pigment-containing layer, core layer, and adhesive layer can be arranged sequentially, and simultaneously extrusion laminated. However, in this case, it is preferable not to blend any pigment into the adhesive layer so that the die lip is not contaminated by the adhesive layer. In other words, it is preferable to mold it integrally in the state wherein a non-pigment-containing layer is arranged on both sides of the core layer.

Various methods can be employed when carrying out the coating, for example, reverse roll coating, gravure coating, curtain spray coating, die coating, extrusion, and other industrially applicable coating methods.

Such a semiconductor processing sheet of the present invention usually has the properties required for semiconductor processing sheets, for example, strength of the base layer, elasticity, tensile storage modulus, coefficient of extension, tensile strength, adhesive strength, peel strength and the like, and such properties can be brought out by the appropriate selection of the material used in the various layers, additives, thickness, laminate structure, lamination method, and the like.

Semiconductor processing sheets of the present invention are described in more detail in the working examples below.

### Working Example 1

A resin was prepared as raw materials from EVA resin (ethylene/vinyl acetate copolymer resin, vinyl content 10%, Mitsui-DuPont (Ltd.) P1007), and a resin in which pigment of 0.05 parts by weight of copper phthalocyanine powder was added with respect to 99.95 parts by weight of the EVA resin. A sheet constituting a base layer was obtained by tri-layer extrusion using a single-screw extruder from EVA resin and the pigment-containing resin (as an intermediate layer). In the sheet obtained, the pigment-containing resin layer had an 80 μm thickness, and EVA resin layers of the two sides thereof had thicknesses of 10 μm (total thickness: 100 μm).

Moreover, an acrylic adhesive (3 parts isocyanate cross-linker (Coronate L) was added to a polymerized polymer in toluene solution of 100 parts BA and 10 parts AA) was coated onto a silicone-treated polyester film with a thickness of 15 μm, and this was dried at 120° C. to produce the adhesive layer transfer sheet.

The adhesive layer side of the adhesive layer transfer sheet was attached to a sheet constituting the base layer obtained above, and the adhesive layer was transferred to produce a semiconductor processing sheet.

### Working Example 2

A resin was prepared as raw materials from LDPE resin (high-pressure, low-density polyethylene, molecular weight: 3.4×10⁴), and a resin in which pigment of 0.05 parts by weight of copper azomethine yellow was added with respect to 99.95 parts by weight of the LDPE resin. A sheet constituting a base film was obtained by tri-layer extrusion using a single-screw extruder from LDPE resin and the pigment-containing resin (as an intermediate layer). In the sheet obtained, the pigment-containing resin layer had an 80 μm thickness, and LDPE resin layers of the two sides thereof had thicknesses of 10 μm (total thickness: 100 μm).

The adhesive layer side of the adhesive layer transfer sheet similar to that of

Working Example 1 was attached to the sheet constituting the base layer obtained above, and the adhesive layer was transferred to produce a semiconductor processing sheet.

### Working Example 3

Using LDPE resin (high-pressure, low-density polyethylene, molecular weight: 3.4×10⁴), and a resin added pigment of 0.05 parts by weight of copper azomethine yellow with respect to 99.95 parts by weight of the LDPE resin as raw materials, a sheet constituting the base layer was obtained di-layer extrusion using a single-screw extruder. In the sheet obtained, the pigment-containing resin layer had an 80 μm thickness, and the LDPE resin layer had thicknesses of 20 μm (total thickness: 100 μm).

The adhesive layer side of the adhesive layer transfer sheet similar to that of Working Example 1 was attached to the LPDE resin side of the base layer obtained above, except that the thickness of the adhesive layer had a 30 μm thickness, and the adhesive layer was transferred to produce a semiconductor processing sheet.

### Working Example 4

A sheet was obtained by tri-layer extrusion using a single-screw extruder from a resin, in which, as a law material, hydrogenated ethylene thermoplastic resin (“Tuftec H1052” manufactured by Ashahi Kasei Chemicals Corporation) with added pigment of 0.05 parts by weight of copper azomethine yellow for 99.95 parts by weight of the resin as an intermediate layer and polypropylene resin as outer layers. In the sheet obtained, the pigment-containing resin layer had an 80 μm thickness, and polypropylene layers of the two side thereof had thicknesses of 10 μm (total thickness: 100 μm).

The adhesive layer side of the adhesive layer transfer sheet similar to that of Working Example 1 was attached to the sheet constituting the base layer obtained above, and the adhesive layer was transferred to produce a semiconductor processing sheet.

### Working Example 5

A sheet was obtained by tri-layer extrusion using a single-screw extruder from a resin, in which, as a law material, EVA resin (ethylene/vinyl acetate copolymer resin, vinyl content 10%, Mitsui-DuPont (Ltd.) P1007) with added pigment of 0.05 parts by weight of copper azomethine yellow for 99.95 parts by weight of the resin as an intermediate layer and LDPE resin as outer layers. In the sheet obtained, the pigment-containing resin layer had an 80 μm thickness, and LDPE layers of the two side thereof had thicknesses of 10 μm (total thickness: 100 μm).

An acrylic adhesive, which is dissolved 20 g of polymer obtained in the reference example described in JP2001-234136A in 80 g of ethyl acetate, and 0.2 g of polyisocyanate compound and 0.4 g of multi-functional epoxy compound was added thereto and stirred until homogenous, was coated onto a film base layer made from polyester film with a thickness of 50 μm, and this was dried at 70 and 130° C. for 3 minutes, respectively, to produce the adhesive layer with a thickness of 35 μm.

The adhesive layer side of the adhesive layer transfer sheet similar to that of Working Example 1 was attached to the sheet constituting the base layer obtained above, and the adhesive layer was transferred to produce a semiconductor processing sheet.

### Comparative Example 1

The resin used as raw material had added pigment of 0.04 parts by weight for 99.96 parts by weight of the EVA resin, and a sheet constituting the base layer was obtained by single-layer extrusion using a single-screw extruder. The sheet obtained was a pigment-containing resin with a thickness of 100 μm.

The adhesive layer side of the adhesive layer transfer sheet similar to that of Working Example 1 was attached to the sheet constituting the base layer obtained above, and the adhesive layer was transferred to produce a semiconductor processing sheet.

Furthermore, the state of contamination of the die lip was measured after film extrusion when the abovementioned working examples and comparative example were extrusion molded continuously with the machine operated for 24 hours and 96 hours.

Additionally, the parameters below were evaluated at the appropriate time for the semiconductor processing sheets obtained from the working examples and comparative example.

(State of Contamination of the Die Lip)

After formation of the film, the non-pigment-containing LDPE material was run at constant speed for 10 minutes, after which the die was taken apart and inspected visually to confirm the presence or absence of pigment adhering to the lip portion.

(Film Thickness Variation)

The thickness of the films was measured in the cross-machine direction after film formation using a 1/10,000 dial gauge at intervals of 10 mm.

(Maximum thickness−minimum thickness)×100÷(mean thickness)=film thickness variation (%).

(Amount of Copper Transferred)

The amount of copper transferred from the front and back surfaces of each sheet to a wafer was measured using ICP-MS.

In this measurement method, the semiconductor processing sheet was first adhered to a silicon wafer (mirror surface, 100 mm thick), then a rubber roller with a fixed load of 2 kg was rolled back and forth over the sheet, after which the sheet was peeled off. Next, the surface side of the silicon wafer to which the sheet was adhered/peeled off was etched with a quantity of hydrofluoric acid sufficient for the entire amount of the oxide layer. The entire amount of the solution obtained using the etchant was collected in an evaporating dish, this was heated and evaporated to dryness, and the residue was dissolved in acid to give the test solution for measurement.

Next, the test solution for measurement obtained was measured using ICP-MS.

The number of moles was calculated by dividing the amount (ng) of the element obtained by the atomic weight of copper, and this was converted to the number of atoms by multiplying by Avogadro's number. This value was divided by the surface area of the etched silicon wafer (for example, 78.5 cm²) to calculate the number of atoms per unit surface area (atoms/cm²).

Table 1 illustrates the results thereof.

TABLE 1

| | After continuous | After continuous extrusion for 96 h | | |
|---|---|---|---|---|
| | extrusion for 24 h | | Film | Cu ion amount of |
| | State of contamination of the | | thickness | front and back |
| | die lip after film extrusion | | variation | surfaces by ICP |
| Example | | | | |
| 1 | pigment adhering: non | pigment adhering: non | 3.3% | below detection limit |
| 2 | pigment adhering: non | pigment adhering: non | 3.8% | below detection limit |
| 3 | pigment adhering: non | pigment adhering: non | 3.2% | below detection limit |
| 4 | pigment adhering: non | pigment adhering: non | 3.1% | below detection limit |
| 5 | pigment adhering: non | pigment adhering: non | 3.5% | below detection limit |
| Comparative | | | | |
| Example | | | | |
| 1 | pigment adhering: part | pigment adhering: full part | 7.2% | 2 × 10¹⁰atoms/cm² |

In the abovementioned working examples, the ICP-MS measurements confirmed that the amounts of copper transferred were at or below the detection limit for the surfaces of all of the base layer sides and adhesive layer sides of the semiconductor processing sheets obtained. These measurements were obtained according to the methods mentioned above. In addition, in the results from total reflection X-ray fluorescence, X-ray photoelectron spectroscopy, and the like, the measured values for metal were confirmed to be respectively at or below approximately 1×10¹² atoms/cm² and at or below 16 atom %.

From the results in Table 1 for the working examples of the present invention, even when used as semiconductor processing sheets in the manufacturing processes for semiconductors, if non-pigment-containing layers are arranged on the outermost surfaces of the base layer, pigment contamination of the manufacturing facility, the manufacturing equipment, and the inner surface of the die lip thereof can be substantially prevented, and furthermore it is known that higher precision in the thickness of the semiconductor processing sheets can be achieved.

Additionally, since effective prevention of pigment contamination of the die lip inner surfaces can be achieved, processes for washing die lips and the like can be substantially reduced, and continuous operation of the film manufacturing equipment can be realized.

Furthermore, it is possible to prevent pigment contamination of the adhesive materials in question.

### INDUSTRIAL APPLICABILITY

Semiconductor processing sheets of the present invention contain pigment, and have broad applicability as adhesive sheets when there are concerns about contamination of the film-forming equipment that produces them, for example the inner surfaces of the die lips.

1. A semiconductor processing sheet comprising a base layer having a plastic sheet containing pigment as a core layer, wherein a non-pigment-containing layer is arranged in the outermost layer on front and back main surfaces of the core layer.

2. The semiconductor processing sheet according to claim 1, wherein the non-pigment-containing layer arranged in the outermost layer on one main surface of the core layer is formed by an adhesive layer.

3. The semiconductor processing sheet according to claim 1, wherein the non-pigment-containing layer arranged on at least one of the front and back main surfaces is formed using the same material that is used to the core layer.

4. The semiconductor processing sheet according to claim 1, wherein the sheet is used as a wafer back surface polishing sheet.
